(19) United States
(12) Patent Application Publication
(10) Pub. No.: US 2026/0304493 A1
(43) Pub. Date: Oct. 1, 2026

(54) TRANSMISSION CONFIGURATION INDICATOR (TCI) STATES FOR CELL SWITCH

(71) Applicant: Nokia Technologies Oy, Espoo (FI)

(72) Inventors: Timo KOSKELA, Oulu (FI); Sanjay GOYAL, Murray Hill, NJ (US); Keeth Saliya Jayasinghe LADDU, Espoo (FI)

(21) Appl. No.: 19/481,057

(22) PCT Filed: Apr. 19, 2024
(86) PCT No.: PCT/EP2024/060656

§ 371 Date: Nov. 3, 2025

Related U.S. Application Data
(60) Provisional application No. 63/503,532, filed on May 22, 2023.

(51) Int. Cl. H04W 74/0833; H04B 17/318; H04W 36/00

(52) U.S. Cl. CPC H04W 74/0833; H04B 17/328; H04W 36/0072

(57) ABSTRACT

A user equipment apparatus includes processor(s) and at least one memory. The memory stores instructions which, when executed by the processor(s), cause the user equipment apparatus at least to: receive, from a serving cell, one or more of activated transmission configuration indicator (TCI) states for a candidate cell; receive, from the serving cell, a cell switch command to switch from the serving cell to the candidate cell, where the candidate cell is a target cell of the cell switch command; in response to the cell switch command, perform random access procedure with the target cell, where the target cell becomes a new serving cell after the random access procedure is successfully completed; and after the random access procedure with the target cell is successfully completed, maintain at least one of the one or more of activated TCI states as one or more activated TCI states for the new serving cell.

### FIELD

Various example embodiments relate generally to wireless networking and, more particularly, to transmission configuration indicator (TCI) states for mobility in wireless networking.

### BACKGROUND

Wireless networking provides significant advantages for user mobility. A user's ability to remain connected while on the move provides advantages not only for the user, but also provides greater efficiency and productivity for society as a whole. As user expectations for connection reliability, data speed, and device battery life, become more demanding, technology for wireless networking must also keep pace with such expectations. Accordingly, there is continuing interest in improving wireless networking technology. For that purpose, the cellular standards have developed cell switching on various protocol layers: conventional Layer 3 handovers have been present for several generations. On top of that, a conditional handover was introduced to improve the reliability of handovers. Recent development has contemplated lower-layer handovers known as Layer1/Layer 2 triggered mobility (LTM).

### SUMMARY

In accordance with aspects of the present disclosure, a user equipment apparatus includes one or more processors and at least one memory. The at least one memory stores instructions which, when executed by the one or more processors, cause the user equipment apparatus at least to

In an aspect of the present disclosure, a user equipment apparatus includes one or more processors and at least one memory storing instructions. The instructions, when executed by the one or more processors, cause the user equipment apparatus at least to: receive, from a serving cell, one or more activated transmission configuration indicator (TCI) states for a candidate cell; receive, from the serving cell, a cell switch command to switch from the serving cell to the candidate cell, where the candidate cell is a target cell of the cell switch command; in response to the cell switch command, perform random access procedure with the target cell, where the target cell becomes a new serving cell after the random access procedure is successfully completed; and after the random access procedure with the target cell is successfully completed, maintain at least one of the one or more of activated TCI states as one or more activated TCI states for the new serving cell.

In an aspect of the user equipment apparatus, the instructions, when executed by the one or more processors, may further cause the user equipment apparatus at least to: in response to the cell switch command, determine that no timing advance (TA) value has been provided for the target cell in the cell switch command; and receive a TA value for the target cell via the random access procedure.

In an aspect of the user equipment apparatus, the instructions, when executed by the one or more processors, may further cause the user equipment apparatus at least to: prior to performing the random access procedure with the target cell, receive an indication of one TCI state of the one or more activated TCI states; and after the random access procedure with the target cell is successfully completed, maintain the indication of the one TCI state as an indicated TCI state for the new serving cell.

In an aspect of the user equipment apparatus, the one or more activated TCI states for the new serving cell may include only the indicated TCI state for the new serving cell, and among the one or more activated TCI states, TCI states other than the indicated TCI state are deactivated.

In an aspect of the user equipment apparatus, the instructions, when executed by the one or more processors, may further cause the user equipment apparatus at least to: prior to performing the random access procedure with the target cell, receive in the cell switch command an indication of one TCI state of the one or more activated TCI states; and after the random access procedure with the target cell is successfully completed, determine, based on the cell switch command, to one of: maintain at least one of the one or more activated TCI states but not maintain the indication of the one TCI state, maintain the indication of the one TCI state but not maintain the one or more activated TCI states, or maintain at least one of the one or more activated TCI states and maintain the indication of the one TCI state.

In an aspect of the user equipment apparatus, the instructions, when executed by the one or more processors, may further cause the user equipment apparatus at least to: prior to performing the random access procedure with the target cell, receive an indication of one TCI state of the one or more of activated TCI states; and after the random access procedure with the target cell is successfully completed, determine to not maintain the indication of the one TCI state as an indicated TCI state for the new serving cell.

In an aspect of the user equipment apparatus, the determination to not maintain the indication of the one TCI state may be based on: a CORESET index value being associated with at least one type of physical downlink control channel (PDCCH) common search space (CSS), and a configuration having at least one field value corresponding to not applying the indication of the one TCI state. The instructions, when executed by the one or more processors, may further cause the user equipment apparatus at least to, based on the determination, apply a quasi co-located (QCL) source for monitoring at least one CSS on at least one CORESET based on a reference signal selected for the random access procedure.

In an aspect of the user equipment apparatus, in performing the random access procedure with the target cell, the instructions, when executed by the one or more processors, may cause the user equipment apparatus at least to select one of a signal synchronization block (SSB) or a quasi-co-located (QCL) source SSB, corresponding to the indicated one TCI state, if the respective SSB or QCL source SSB has a reference signal receive power (RSRP) that is above a threshold value.

In an aspect of the user equipment apparatus, the instructions, when executed by the one or more processors, may further cause the user equipment apparatus at least to: determine that a timing advance (TA) value was acquired prior to the cell switch command and that the cell switch command does not include a TA value; and based on the determination, decide that random access procedure is triggered.

In an aspect of the user equipment apparatus, the instructions, when executed by the one or more processors, may further cause the user equipment apparatus at least to: in response to the cell switch command, determine that a timing advance (TA) value for the target cell has been acquired and that one of: uplink resources are configured for the target cell, or scheduling of the uplink resources is to be monitored; based on the determination, transmit an uplink message to the target cell using the uplink resources; and determine that the random access procedure is triggered before the uplink message is successfully transmitted to the target cell, where the random access procedure is performed in response to the random access procedure being triggered.

In an aspect of the user equipment apparatus, the instructions, when executed by the one or more processors, may further cause the user equipment apparatus at least to: prior to performing the random access procedure with the target cell, receive an indication of one TCI state of the one or more activated TCI states; and after the random access procedure with the target cell is successfully completed, maintain the indication of the one TCI state as an indicated TCI state for the new serving cell.

In an aspect of the user equipment apparatus, the instructions, when executed by the one or more processors, may further cause the user equipment apparatus at least to: prior to performing the random access procedure with the target cell, receive an indication of one TCI state of the one or more activated TCI states; and after the random access procedure with the target cell is successfully completed, determine to not maintain the indication of the one TCI state as an indicated TCI state for the new serving cell.

In an aspect of the user equipment apparatus, the instructions, when executed by the one or more processors, may further cause the user equipment apparatus at least to: receive, from the serving cell, for each candidate cell of a plurality of candidate cells, one or more respective activated transmission configuration indicator (TCI) states for the respective candidate cell, where the plurality of candidate cells includes the candidate cell.

In an aspect of the user equipment apparatus, the cell switch command may be a layer 1/layer 2 triggered mobility (LTM) cell switch command.

In accordance with aspects of the present disclosure, a processor-implemented method includes: receiving, from a serving cell, one or more activated transmission configuration indicator (TCI) states for a candidate cell; receiving, from the serving cell, a cell switch command to switch from the serving cell to the candidate cell, where the candidate cell is a target cell of the cell switch command; in response to the cell switch command, performing random access procedure with the target cell, where the target cell becomes a new serving cell after the random access procedure is successfully completed; and after the random access procedure with the target cell is successfully completed, maintaining the one or more activated TCI states as activated TCI states for the new serving cell.

In an aspect of the processor-implemented method, the method may further include: in response to the cell switch command, determining that no timing advance (TA) value has been provided for the target cell in the cell switch command; and receiving a TA value for the target cell via the random access procedure.

In an aspect of the processor-implemented method, the method may further include: prior to performing the random access procedure with the target cell, receiving an indication of one TCI state of the one or more activated TCI states; and after the random access procedure with the target cell is successfully completed, maintaining the indication of the one TCI state as an indicated TCI state for the new serving cell.

In an aspect of the processor-implemented method, the one or more activated TCI states for the new serving cell may include only the indicated TCI state for the new serving cell, and among the one or more activated TCI states, TCI states other than the indicated TCI state are deactivated or not considered.

In an aspect of the processor-implemented method, the method may further include: prior to performing the random access procedure with the target cell, receiving an indication of one TCI state of the one or more activated TCI states; and after the random access procedure with the target cell is successfully completed, determining, based on the cell switch command, to one of: maintain at least one of the one or more activated TCI states but not maintain the indication of the one TCI state, maintain the indication of the one TCI state but not maintain the one or more activated TCI states, or maintain at least one of the one or more activated TCI states and maintain the indication of the one TCI state.

In an aspect of the processor-implemented method, the method may further include: prior to performing the random access procedure with the target cell, receiving an indication of one TCI state of the one or more of activated TCI states; and after the random access procedure with the target cell is successfully completed, determining to not maintain the indication of the one TCI state as an indicated TCI state for the new serving cell.

In an aspect of the processor-implemented method, the determination to not maintain the indication of the one TCI state may be based on: a CORESET index value being associated with at least one type of physical downlink control channel (PDCCH) common search space (CSS), and a configuration having at least one field value corresponding to not applying the indication of the one TCI state. The method further includes, based on the determination, applying a quasi co-located (QCL) source for monitoring at least one CSS on at least one CORESET based on a reference signal selected for the random access procedure.

In an aspect of the processor-implemented method, performing the random access procedure with the target cell may include selecting one of a signal synchronization block (SSB) or a quasi-co-located (QCL) source SSB, corresponding to the indicated one TCI state, if the respective SSB or QCL source SSB has a reference signal receive power (RSRP) that is above a threshold value.

In an aspect of the processor-implemented method, the method may further include: determining that a timing advance (TA) value was acquired prior to the cell switch command and that the cell switch command does not include a TA value; and based on the determination, deciding that random access procedure is triggered.

In an aspect of the processor-implemented method, the method may further include: in response to the cell switch command, determining that a timing advance (TA) value for the target cell has been acquired and that one of: uplink resources are configured for the target cell, or scheduling of the uplink resources is to be monitored; based on the determination, transmitting an uplink message to the target cell using the uplink resources; and determining that the random access procedure is triggered before the uplink message is successfully transmitted to the target cell, where the random access procedure is performed in response to the random access procedure being triggered.

In an aspect of the processor-implemented method, the method may further include: prior to performing the random access procedure with the target cell, receiving an indication of one TCI state of the one or more activated TCI states; and after the random access procedure with the target cell is successfully completed, maintaining the indication of the one TCI state as an indicated TCI state for the new serving cell.

In an aspect of the processor-implemented method, the method may further include: prior to performing the random access procedure with the target cell, receiving an indication of one TCI state of the one or more activated TCI states; and after the random access procedure with the target cell is successfully completed, determining to not maintain the indication of the one TCI state as an indicated TCI state for the new serving cell.

In an aspect of the processor-implemented method, the method may further include: receiving, from the serving cell, for each candidate cell of a plurality of candidate cells, one or more respective activated transmission configuration indicator (TCI) states for the respective candidate cell, where the plurality of candidate cells includes the candidate cell.

In an aspect of the processor-implemented method, the cell switch command may be a layer 1/layer 2 triggered mobility (LTM) cell switch command.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment apparatus (UE), according to one illustrated aspect of the disclosure;

FIG. 2 is a diagram of an example embodiment of transmit and receive beams for wireless networking between a network apparatus and a user equipment apparatus (UE), according to one illustrated aspect of the present disclosure;

FIG. 3 is a diagram of an example embodiment of a UE sweeping receive beams for synchronization signal block (SSB) bursts, according to one illustrated aspect of the disclosure;

FIG. 4 is a diagram of an example embodiment of a layer 1/layer 2 triggered mobility (LTM) scenario, according to one illustrated aspect of the present disclosure;

FIG. 5 is a diagram of an example embodiment of a contention-based random access procedure, according to one illustrated aspect of the disclosure;

FIGS. 6A and 6B are diagrams of an example embodiment of signals and operations among a UE, a central unit (CU), a source distributed unit (DU), and a target DU, relating to LTM, according to one illustrated aspect of the disclosure;

FIG. 7 is a diagram of an example embodiment of signals and operations among a UE, a source cell, and a target cell, relating to transmission configuration indicator (TCI) states before, during, and after a cell switch, according to one illustrated aspect of the disclosure;

FIG. 8 is a diagram of an example embodiment of signals and operations among a UE, a source cell, and a target cell, in a cell switch scenario without a timing advance (TA) value, according to one illustrated aspect of the disclosure;

FIG. 9 is a diagram of an example embodiment of signals and operations among a UE, a source cell, and a target cell, in a cell switch scenario with a timing advance (TA) value, according to one illustrated aspect of the disclosure;

FIG. 10 is a flow diagram of example operations of a UE for cell switch, according to one illustrated aspect of the present disclosure;

FIG. 11 is a flow diagram of example operations of a network apparatus for cell switch, according to one illustrated aspect of the present disclosure; and

FIG. 12 is a diagram of example embodiment of components of a UE or of a network apparatus, according to one illustrated aspect of the present disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advance, 6G (and beyond) and 802.11ax (Wi-Fi 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

Because a UE may travel from one area to another area, handover or mobility procedures can be important to support continued communication (without any interruption or at least a minimal interruption) of the UE with the network. In an example, the UE may be configured to monitor certain reference signal(s) (e.g., SSBs, channel state information-reference signals (CSI-RSs), DL reference signals (RSs)) from one or more network apparatuses, perform signal measurements of the reference signal(s), and report those signal measurements to the network so that a determination of a handover of the UE to a neighboring cell can be made (e.g., upon a degradation in signal quality is detected). The initiation of a handover may typically be made from the network. In an example of 5G NR, a handover initiation or handover command may be signaled via higher layer signaling, e.g., layer 3 or radio resource control (RRC) signaling. The higher layer signaling may involve the network, and thus can have a high latency. In various situations, a UE may benefit from a more efficient handover procedure triggered via lower layer signaling, e.g., L1/L2 signaling, that has a lower latency than the higher layer signaling. As used herein, a handover triggered via lower layer signaling may be referred to as lower layer triggered mobility (LTM). In some instances, a candidate cell for LTM may be referred to as an LTM candidate cell.

As used herein, the term “cell switch” means and refers to any change of cell, whether the change is triggered via Layer 1 signaling, Layer 2 signaling, and/or Layer 3 signaling, and/or other signaling. The cell switch may be for a terminal device in a RRC connected mode and, thus, the cell switch may involve bidirectional signaling between the terminal device and at least one network node of a radio access network, typically at least a source network node and a target network node of the cell switch. The present disclosure primarily uses LTM as an example of cell switch, but it is intended and shall be understood that the present disclosure may operate with a Layer 3 handover or any cell switch.

The present disclosure may use the term “serving cell” to refer to a network node or network apparatus (or a portion thereof) that services a UE, may use the term “candidate cell” to refer to a network node or network apparatus (or portion thereof) that is a potential target of a cell switch command, and may use the term “target cell” to refer to a network node or a network apparatus (or portion thereof) that is the target of a cell switch command. In some examples, the LTM target may also be a serving cell (e.g., the target is may be an “SCell,” i.e., a secondary cell in carrier aggregation).

As used herein, the terms “transmit towards,” “receive from,” and “cooperate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

Aspects of the present disclosure provide for a UE to maintain activated TCI states for a target cell prior to a cell switch command for the UE to switch from its serving cell to the target cell and, additionally, provide for the UE to maintain such activated TCI states, after the cell switch to the target cell as the new serving cell, as activated TCI states for the new serving cell. In embodiments, the UE also maintains an indicated TCI state for the target cell, provided prior to the cell switch, as the indicated TCI state for the new serving cell. Advantages of such aspects include reducing or eliminating delay in data communication readiness after a UE and a target cell successfully complete random access procedures, leading to improved time and resource utilization at the UE and at new serving cell.

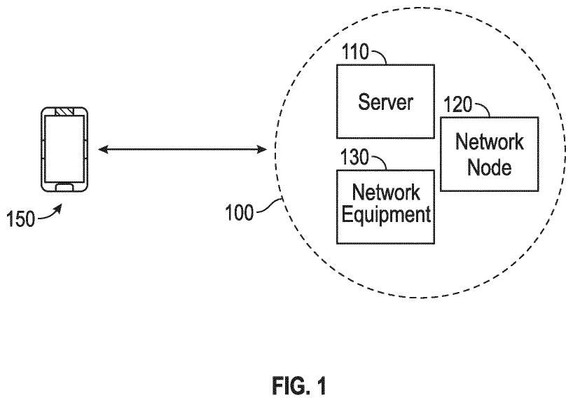

FIG. 1 is a diagram depicting an example of wireless networking between a network system 100 and a user equipment apparatus (UE) 150. The network system 100 may include one or more network nodes 120, one or more servers 110, and/or one or more network equipment 130 (e.g., test equipment). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing aspects of 5G NR, among others. The present disclosure describes embodiments related to 5G NR and embodiments that involve aspects defined by 3rd Generation Partnership Project (3GPP). However, it is contemplated that embodiments relating to other wireless networking technologies are encompassed within the scope of the present disclosure.

The following description provides further details of examples of network nodes. In a 5G NR network, a gNodeB (also known as gNB) may include, e.g., a node that provides NR user plane and control plane protocol terminations towards the UE and that is connected via a NG interface to the 5G core (5GC), e.g., according to 3GPP TS 38.300 V16.6.0 (2021-06) section 3.2, which is hereby incorporated by reference herein.

A gNB supports various protocol layers, e.g., Layer 1 (L1)—physical layer, Layer 2 (L2), and Layer 3 (L3).

The layer 2 (L2) of NR is split into the following sublayers: Medium Access Control (MAC), Radio Link Control (RLC), Packet Data Convergence Protocol (PDCP) and Service Data Adaptation Protocol (SDAP), where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC quality of service (QOS) flows;
Control channels include broadcast control channel (BCCH) and physical control channel (PCCH).

Layer 3 (L3) includes, e.g., radio resource control (RRC), e.g., according to 3GPP TS 38.300 V16.6.0 (2021-06) section 6, which is hereby incorporated by reference herein.

A gNB central unit (gNB-CU) includes, e.g., a logical node hosting, e.g., radio resource control (RRC), service data adaptation protocol (SDAP), and packet data convergence protocol (PDCP) protocols of the gNB or RRC and PDCP protocols of the en-gNB, that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB Distributed Unit (gNB-DU) includes, e.g., a logical node hosting, e.g., radio link control (RLC), media access control (MAC), and physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

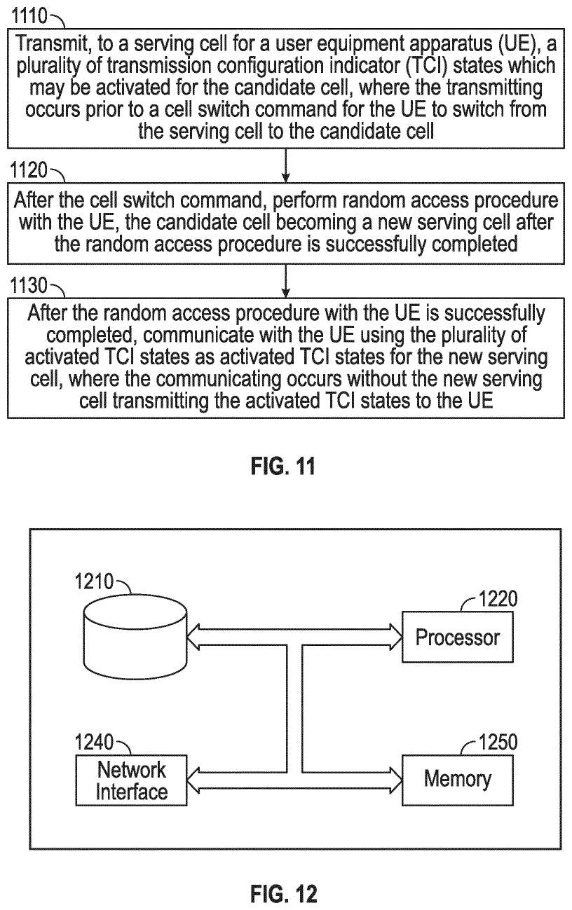

As used herein, the term “network node” may refer to any of a gNB, a gNB-CU, or a gNB-DU, or any combination of them. A RAN (radio access network) node or network node such as, e.g., a gNB, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-)layer of a RAN (radio access network), e.g., layer 2 and/or layer 3. Different functional splits between the central and distributed unit are possible. An example of such an apparatus and components will be described in connection with FIG. 12 below.

The gNB-CU and gNB-DU parts may, e.g., be co-located or physically separated. The gNB-DU may even be split further, e.g., into two parts, e.g., one including processing equipment and one including an antenna. A central unit (CU) may also be called BBU/REC/RCC/C-RAN/V-RAN, O-RAN, or part thereof. A distributed unit (DU) may also be called RRH/RRU/RE/RU, or part thereof. Hereinafter, in various example embodiments of the present disclosure, a network node, which supports at least one of central unit functionality or a layer 3 protocol of a radio access network, may be, e.g., a gNB-CU. Similarly, a network node, which supports at least one of distributed unit functionality or a layer 2 protocol of the radio access network, may be, e.g., a gNB-DU.

A gNB-CU may support one or multiple gNB-DUs. A gNB-DU may support one or multiple cells and, thus, could support a serving cell for a user equipment apparatus (UE) or support a candidate cell for handover, dual connectivity, and/or carrier aggregation, among other procedures.

The user equipment apparatus (UE) 150 may be or include a wireless or mobile device, an apparatus with a radio interface to interact with a RAN (radio access network), a smartphone, an in-vehicle apparatus, an IoT device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 12. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (packet data units). Persons skilled in the art will understand RRC protocol as well as other procedures a UE may perform.

With continuing reference to FIG. 1, in the example of a 5G NR network, the network system 100 provides one or more cells, which define a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station.

FIG. 1 provides an example and is merely illustrative of a network system 100 and a UE 150. Persons skilled in the art will understand that the network system 100 includes components not illustrated in FIG. 1 and will understand that other user equipment apparatuses may be in communication with the network system 100.

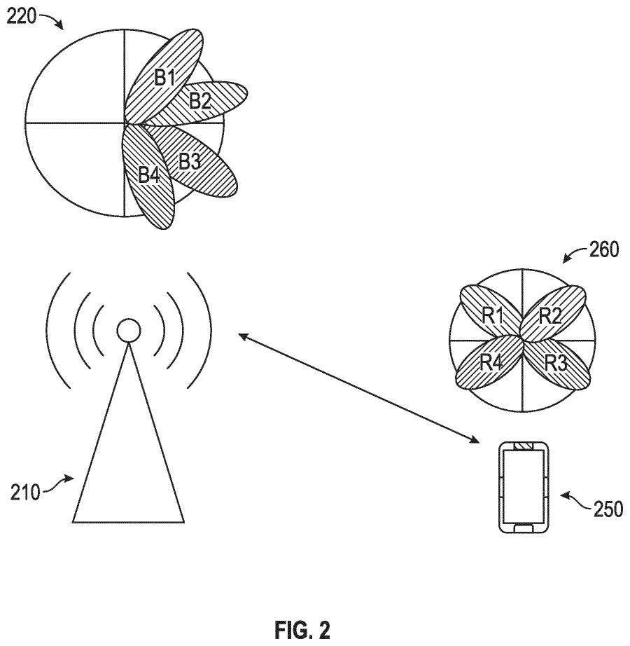

FIG. 2 is a diagram of an example embodiment of wireless networking between a network apparatus 210 and a user equipment apparatus (UE) 150. The network apparatus 210 is configured to form beams 220 in multiple directions, and the UE 150 is also configured to form beams 260 in multiple directions. As persons skilled in the art will understand, the capability to beamform in multiple directions may be implemented using arrangements of multiple radiating elements, which may also be referred to as “arrays” of radiating elements. Beamforming (also known as spatial filtering) achieves directional signal transmission or reception by utilizing separate arrays and/or by combining elements in an array in such a way that signals at particular angles result in constructive or destructive interference. Beamforming for a transmission is implemented by controlling the phase and relative amplitude of the transmission signal at each radiating element in an array, in order to create a desired pattern of constructive and destructive interference in a desired wavefront. Beamforming for a reception, in contrast, is implemented by combining information from different elements of an array in such a way that radiation in a target spatial region is preferentially observed.

In the illustrated example, the network apparatus 210 (e.g., gNodeB or part thereof) and the UE 150 may each be equipped with one or more antenna panels or antenna arrays with antenna elements that can be configured to perform beamforming in certain spatial directions and/or within certain spatial angular sectors or widths.

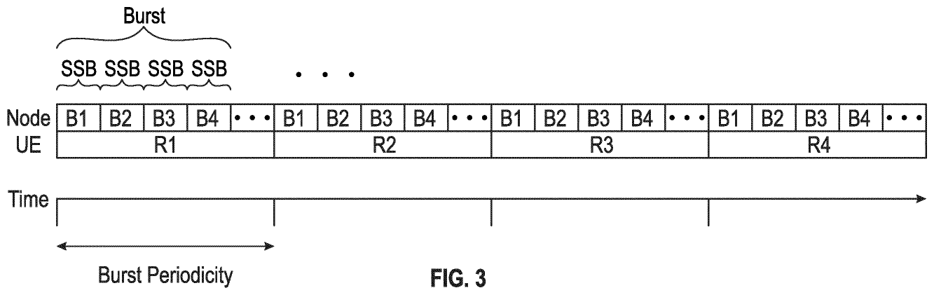

With continuing reference to FIG. 1, various examples of beams 220 are illustrated for the network apparatus 210 and various examples of beams 260 are illustrated for the UE 150. A consequence of using highly directive beams is that some of the network apparatus beams 120 may not be usable with some of the UE beams 160 due to large directional differences. Thus, in embodiments, the UE 150 “sweeps” its beams 260 and the network apparatus 210 “sweeps” its beams 220 to determine which beam-pairing has the highest signal power and, therefore, is best usable for communications. It is possible for beams that are not fully directionally-aligned to have the highest signal power due to various propagating conditions. The sweeps will be described in more detail in connection with FIG. 3. After identifying such a beam pairing, the UE 150 and the network apparatus 210 may use the identified beams to initiate access procedures for the UE 150 to access the network apparatus 210.

FIG. 3 is a diagram of an example embodiment of a UE sweeping receive beams for SSB bursts. Using the example beams illustrated in FIG. 2, the network apparatus 210 form beams B1, B2, B3, and B4, successively. Each formation of the beams is referred to as a “burst.” The network apparatus 210 may generate the bursts at intervals for the UE 150 to observe. Each time between intervals is referred to as “burst period,” which may be longer than the duration of a burst.

In the example of 5G NR, each beam in a burst transmits information about the beam in what is referred to as a signal synchronization block (SSB). A network apparatus 210, which may be a gNodeB, or part thereof, transmits an SSB in each beam in a burst. In some examples, the network apparatus 210 may operate using one SSB (single beam operation) or using multiple SSBs (multi beam operation). In embodiments, the UE 150 may receive a SSB burst for each of its receive beams. In the example of four receive beams R1, R2, R3, and R4, shown in FIG. 2, receiving the bursts for all four receive beams takes four intervals, as shown in FIG. 3. In some examples, the UE 150 may operate using a single beam (e.g., omnidirectional beam). The SSBs of an SS burst can be provided by one or more (co- or non co-located) TRP(s) (transmit-receive points). The duration between bursts is referred to as “burst periodicity.” In a 5G NR network, SSB bursts can each last 5 ms, and burst periodicity can have a default duration of 20 ms.

In the example of 5G NR, each SSB includes System Information (SI) in the form of Master Information Blocks (MIB) and a number of System Information Blocks (SIB). The SI is divided into Minimum SI and Other SI. Minimum SI includes basic information usable for accessing the network node and information for acquiring any other SI. Minimum SI includes the MIB, which contains cell-barred status information and physical layer information of the cell for receiving further system information (e.g., CORESET#0 configuration). MIB is periodically broadcast on a broadcast channel (BCH). Minimum SI also includes a System Information Block 1 (SIB1), which defines the scheduling of other system information blocks and contains information for accessing the network node. SIB1 may also be referred to as Remaining Minimum SI (RMSI) and is periodically broadcast on a downlink shared channel (DL-SCH).

Referring also to FIG. 2, in an example of the 5th generation new radio (5G NR) as defined by 3rd Generation Partnership Project (3GPP), a unified transmission configuration indicator (TCI) framework is used for beam configurations and/or indications. For instance, the network apparatus 210 may configure the UE 150 with a set of TCI states. Each TCI state may indicate at least a certain beam direction or a group of beam directions, which may correspond to a certain reference signal. In an example, a TCI state can be a downlink (DL) TCI state for DL communication from the network apparatus 210 to the UE 150. In other examples, a TCI state can be an uplink (UL) TCI state for UL communication from the UE 150 to the network apparatus 210. In a further example, a TCI state can be a joint TCI state for UL and DL communications between the network apparatus 210 and the UE 150. The network apparatus 210 may “activate” the UE with at least a subset of the configured TCI states. As used herein, “activating” a TCI state means that a UE 150 may monitor signals transmitted by the network apparatus 210 corresponding to the TCI state, such as reference signals. In examples, activation of a TCI State may mean that the UE is configured monitor at least one reference signal associated with the activated TCI State, e.g., for time/frequency tracking and/or path loss measurement. In examples, activation may mean that a UE 150 is expected to track at least one reference signal corresponding to the activated TCI state. In some examples, the network apparatus 210 may activate one or more of the configured TCI states in the set and exclude one or more of the other configured TCI states in the set. Additionally, to communicate with the UE 150, the network apparatus 210 may select one of the activated TCI states and “indicate” the selected TCI state to the UE 150. As used herein, “indicating” a TCI state means that a UE 150 may be configured to use the beam (identified by downlink reference signals) corresponding to the indicated TCI state to communicate with the network apparatus 210. In various examples, the UE 150 may be prepared to receive indication of at least one of the activated TCI state(s) and prepared to communicate with the network apparatus 210 using the indicated TCI state within specified time limits.

The examples of FIGS. 2 and 3 are merely illustrative. In embodiments, the number and direction of network node beams and the number and direction of UE beams may vary and may be different from those illustrated in FIGS. 2 and 3.

As explained above, a UE may travel from one area to another area, and thus cell switch or mobility procedures (e.g., layer 3 handover or LTM) can be important to support continued communication of the UE with the network. Further, a more efficient cell switch process, such as LTM, can be beneficial in avoiding or at least reducing disruption to the UE service as the UE moves from one cell coverage to another cell coverage.

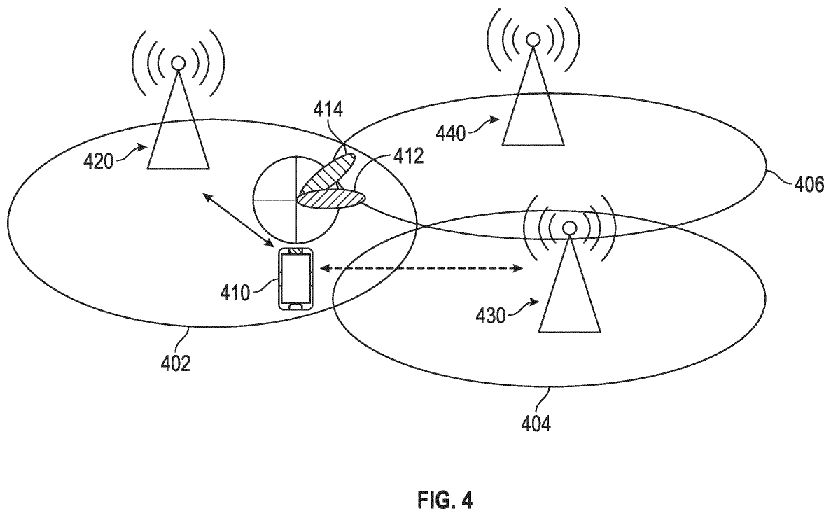

FIG. 4 is a diagram of an example embodiment of an LTM scenario. As shown in FIG. 4, a UE 410 may be in communication with and served by a network apparatus 420 (e.g., a gNB, or a portion thereof) as indicated by the solid arrow. The UE 410 may be substantially similar to the UE 150 of FIG. 1. The network apparatus 420 may be substantially similar to the network apparatus 110 of FIG. 1. The network apparatus 420 that is actively or currently serving the UE 410 may be referred to as a serving cell. As the UE 410 travels towards an edge of a cell or area 402 served by (or under the coverage) of the network apparatus 420, a cell switch procedure may be performed to handover the UE 410 to a neighboring cell served by, e.g., another network apparatus 430, 440. In the illustrated example of FIG. 4, one neighboring cell is served by a network apparatus 430 and another neighboring cell is served by a network apparatus 440. The network apparatus 440 may cover (or serve) a cell or area 406 while the network apparatus 430 may cover an area 404. In some examples, the areas 402, 404, and 406 can partially overlap, as shown. In other examples, the areas 402, 404, and 406 can be non-overlapping. In the context of handover, the neighboring cells can be referred to as candidate cells. In the context of LTM, the neighboring cells can be referred to as LTM candidate cells.

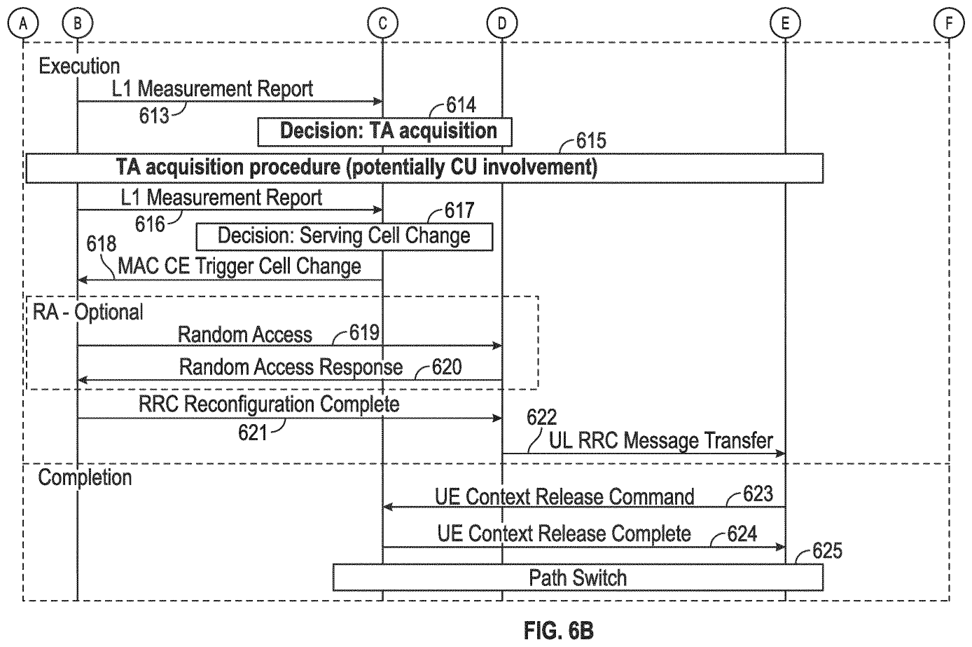

The term Layer 1/Layer 2 triggered mobility (LTM) may also be referred to as L1/L2 triggered mobility, L1/2 inter-cell mobility, L1/2 handover, or lower layer (L1/2) mobility. These terms may be used interchangeably. A L1/L2 signal, message, or command sent by a network node to trigger a cell switch at the UE is referred as a “cell switch command.” In LTM, the decision about a cell switch is based on L1 measurements and is made in the MAC layer in a distributed unit (DU). A cell switch command includes a MAC control element (MAC CE). The cell that is the target of a cell switch command may be referred to herein as a target cell. Mechanisms for LTM will be discussed more fully below with reference to FIGS. 7-11.

According to an aspect of the present disclosure, the network apparatus 420 (the serving cell) may activate the UE 410 with TCI state(s) for candidate cell(s) and may optionally indicate an activated TCI state that may be used by the UE 410 in case of a cell switch. In this regard, the network apparatus 420 may transmit an indication of one or more candidate cells (e.g., the network apparatuses 430 and 440) and an activation of a respective list of one or more TCI states for each of the one or more candidate cell. Upon detection of degradation in operations or communications with the UE 410, the serving cell network apparatus 420 may transmit a cell switch command to the UE 410 via lower layer signaling (e.g., L1/L2 signaling). The cell switch command may indicate a selected one of the one or more candidate cells as a target cell for the cell switch. In response to receiving the cell switch command, the UE 410 may switch to communicate with the target cell by applying at least one of the respective one or more activated TCI states.

The example of FIG. 4 is merely illustrative. In embodiments, the number of candidate cells and the number of activated TCI states (or beams) may vary and may be different from those illustrated in FIG. 4.

A procedure for a UE to establish communications with a target cell is referred to as random access procedure. Random access procedure may be used for initial access, small data transmissions in inactive and transition from RRC_Inactive to RRC_Connected, as well as in beam failure recovery, connection re-establishment, handover, and cell addition, among other procedures which persons skilled in the art will recognize.

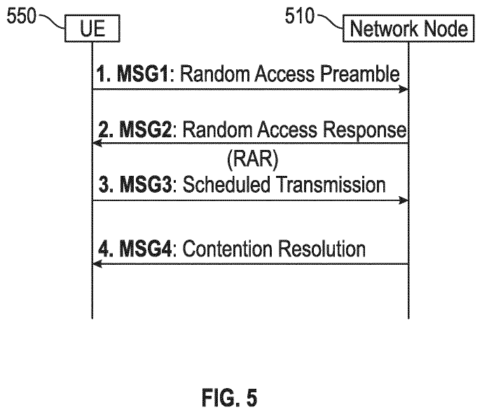

Two types of random access procedures include contention-based random access (CBRA) and contention-free random access (CFRA). FIG. 5 is a diagram of an example of a contention-based random access (CBRA) procedure. In the illustrated example, the signals include a random access preamble (MSG1) transmitted by the UE 550 towards the network node 510 (e.g., gNodeB, or part thereof), a random access response (MSG2) transmitted from the network node 510 towards the UE 550, a schedule transmission (MSG3) transmitted from the UE 550 towards the network node 510, and a contention resolution (MSG4) transmitted from the network node 510 towards the UE 550.

For MSG1, the UE 550 selects a usable random access preamble based on information elements in a signal synchronization block (SSB), such as the SSB described above in connection with FIG. 3. The UE 550 sends the random access preamble (MSG1) towards the network node 510 using a specific time and frequency resource known as random access occasion (RO). The UE 550 also provides an identity, called random access radio network temporary identity (RA-RNTI), to the network so that the network can address it in the next step.

For MSG2, the network node 110 detects the preamble, calculates various quantities, and sends a physical uplink shared channel (PUSCH) uplink (UL) grant towards the UE 550. This is called the random access response (RAR), which is sent as MSG2 addressed to the UE 550 with the relevant RA-RNTI and indicates to the UE 550 where in frequency and when in time it can transmit MSG3 on the PUSCH.

For MSG3, in response to receiving the MSG2 from the network node 510, the UE 550 sends MSG3 using the UL grant provided in the RAR. Because the RAR provides a time resource allocation, the UE 550 sends MSG3 towards the network node 510 at a timing specified by the time resource allocation and is a scheduled transmission. This MSG3 may be called a radio resource control (RRC) connection request message.

For MSG4, the network node 510 may send MSG4 towards the UE 550 for contention resolution. Contention resolution may operate in the manner specified by 3GPP for 5G NR. After the random access procedure, assuming contention resolution is resolved favorably, the UE 550 becomes connected to the network node 510. After establishing a connection, various procedures would be handled by a gNB-CU in accordance with the CU-DU split. Other aspects of contention-based random access (CBRA) will be understood by persons skilled in the art.

Another type of random access procedure is contention-free random access (CFRA) (not shown). In CFRA (not shown), the network node 510 transmits an allocated random access preamble towards the UE 550. The UE 550 receives the allocated random access preamble and sends the random access preamble to the network node 510 in a random access request as MSG1. Then, MSG2 and MSG3 are similar to those described in connection with CBRA. No conflict resolution is needed in CFRA based on use of an allocated random access preamble. Other aspects of contention-free random access (CFRA) will be understood by persons skilled in the art.

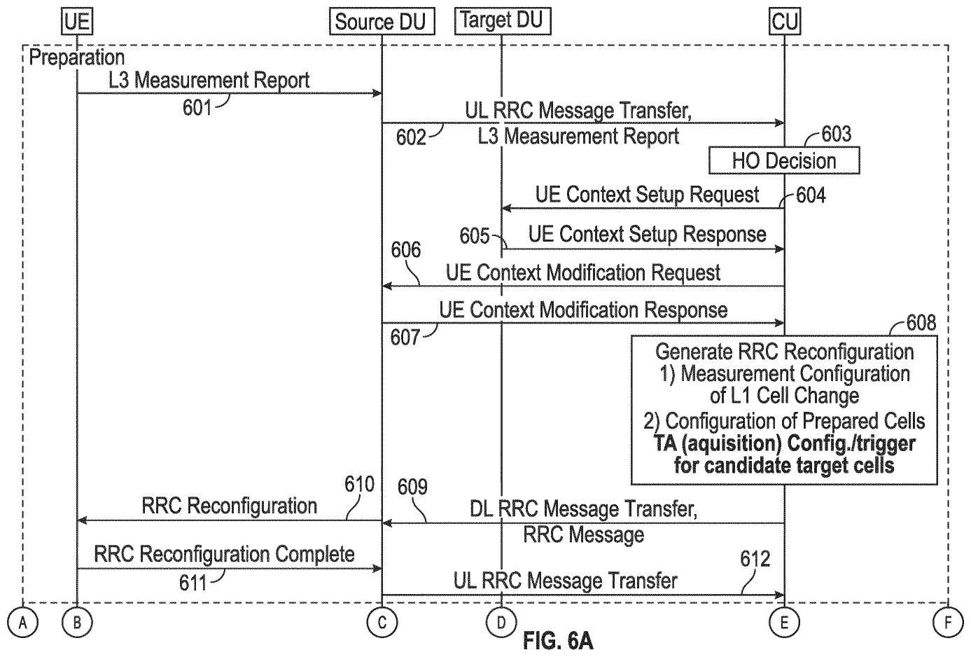

LTM and random access procedure will now be described in connection with FIGS. 6A and 6B. FIGS. 6A and 6B illustrate an example of a cell switch procedure, and it is intended and shall be understood that other types of cell switch procedures (e.g., Layer 3 handover) are within the scope of the present disclosure. Referring now to FIG. 6A and FIG. 6B, example signals and operations for LTM and random access procedure are shown in relation to an inter-DU cell switch procedure. The inter-DU scenario is illustrative, and aspects of the present disclosure may be applied to intra-DU scenarios, as well. Where the source DU and target DU are supported by different CUs, the source DU may be supported by a source CU and the target DU may be supported by a target CU, which can communicate via an Xn interface. As mentioned above, the terms “transmit towards”, “receive from”, and “cooperate with” (and their variations), include communications that may or may not involve communications through one or more intermediate devices or nodes. It is intended that any description referring to a DU shall also be treated as though the description refers to a network node which supports at least one of DU functionality or a layer 2 protocol of a radio access network (RAN). It is intended that any description referring to a CU shall also be treated as though the description refers to a network node which supports at least one of CU functionality or a layer 3 protocol of a radio access network (RAN).

The following paragraphs describe various signals and operations. It will be understood that the described signals may have associated operations and the described operations may have associated signals. Accordingly, a described signal may also be an operation and a described operation may also be a signal.

Prior to signal 601, the UE has established a connection with a DU (i.e., source DU) that supports the serving cell which serves the UE and has established a (logical) connection with the CU that supports the DU.

At signal 601, the UE transmits an L3 measurement report towards the source DU, and the source DU receives the L3 measurement report from the UE. Persons skilled in the art will understand an L3 measurement report, which may include averaged measurement samples of reference signals for a serving cell, for example. An L3 measurement report may indicate, for example, that a UE is nearing an edge of a cell and, thus, handover procedures should be initiated. At signal 602, the source DU forwards the L3 measurement report by transmitting the L3 measurement report towards the CU, and the CU receives the L3 measurement report from the source DU. At operation 603, the CU performs a handover (HO) decision, based on the L3 measurement report, about whether a handover should be prepared. For the illustrated embodiment, the CU decides that a handover should be prepared.

At signal 604, the CU transmits a UE context setup request towards the target DU to prepare the target DU for handover by setting up the UE context in the target DU. The target DU receives the UE context setup request from the CU and sets up the UE context. At signal 605, the target DU provides an acknowledgement by transmitting a UE context setup response towards the CU, and the CU receives the UE context setup response from the target DU. Although one target DU is illustrated, there may be more than one target DU if there are multiple candidate cells. The signals at 604 and 605 may be used for each target DU and for multiple candidate cells. The description below will refer to candidate cell(s) to indicate there may be one candidate cell or multiple candidate cells and, where appropriate, will refer to target DU(s) supporting the candidate cell(s). If a target DU and the source DU are supported by different CUs, the CUS may communicate using an Xn interface. For convenience, only one CU is illustrated (a CU supporting the source DU), but it is intended for the disclosed technology to apply to multi-CU situations, as well.

At signal 606, the CU transmits a UE context modification request towards the source DU for modification of the UE context in the source DU, if needed, and for the provision of the target cell information (e.g., target cell RS configuration, activated or indicated TCI states, etc.). The source DU receives the UE context modification request from the CU, modifies the UE context (if needed), and receives the target cell information. At signal 607, the source DU provides an acknowledgment by transmitting a UE context modification response towards the CU, and the CU receives the UE context modification response from the source DU.

At signals 604-607, the CU, the target DU(s), and the source DU may coordinate with each other regarding timing advance acquisition and configuration for the candidate cell(s). Timing advance refers to information used by a UE to time its uplink transmissions towards a network node to arrive at the network node in alignment with a reception time window. This information may be referred to herein as a timing advance value or TA value, and the process of acquiring a timing advance value may be referred to herein as timing advance acquisition, TA acquisition, acquiring timing advance, or acquiring TA (or variations thereof). As described above herein, the term “acquire” (and its variations) includes acquiring in the first instance or reacquiring after the first instance. In embodiments, the source DU and the target DU(s) may coordinate (via the CU) on the method for the UE to acquire TA. In embodiments, a UE may acquire a separate TA value for each candidate cell.

In embodiments, TA may be acquired based on random access (RA) procedure (either CFRA or CBRA), such as, without limitation, a physical downlink control channel (PDCCH) ordered RA procedure, UE-triggered RA procedure, and/or a higher layer triggered RA procedure from a network node (other than a L3 handover command), among others. In embodiments, TA may be acquired based on non-RA procedure methods, such as, without limitation, sounding reference signal (SRS) based TA acquisition, receive timing difference based mechanisms (such as those in LTE), and/or UE-based TA measurement, among others. Such RA-based and non-RA-based methods for TA acquisition are within the scope of the present disclosure.

At operation 608, the CU creates an RRC reconfiguration message, which includes a measurement configuration for a L1 cell change, a configuration of prepared cells, and a TA acquisition configuration and trigger for the candidate cells. In embodiments, the RRC reconfiguration message may include TA configuration if CU involvement is needed later (in the execution phase). The TA configuration may, for example, specify the method for a UE to acquire TA. In embodiments, the TA acquisition method can be configured/triggered based on L3 measurements by the CU (in coordination with the source-DU).

At signal 609, the CU transmits the RRC reconfiguration message towards the source DU using a downlink (DL) RRC message transfer, and the source DU receives the RRC reconfiguration message from the CU. As mentioned above, the RRC reconfiguration message may include the TA configuration and activated or indicated TCI state information mentioned above. At signal 610, the source DU transmits the RRC reconfiguration message towards the UE to forward it to the UE, and the UE receives the RRC reconfiguration message from the source DU. The UE performs a reconfiguration based on the RRC reconfiguration message. At signal 611, the UE responds by transmitting a RRC reconfiguration complete message towards the source DU using an uplink (UL) RRC message transfer, and the source DU receives the RRC reconfiguration complete message from the UE. At signal 612, the source DU transmits the RRC reconfiguration complete message towards the CU to forward it to the CU, and the CU receives the RRC reconfiguration complete message from the source DU. In embodiments, the signals 609-612 may be described as part of a logical connection between the UE and the CU, such that the CU transmits the RRC message towards the UE, and the UE receives the RRC message from the CU.

In embodiments, the signals and operations 601-612 described above may be referred to as a preparation phase. After the preparation phase is an execution phase.

In the execution phase, the UE, based on its configuration, provides periodic L1 measurement reports. Persons skilled in the art will understand L1 measurements. The L1 measurements may measure signal power of a list of reference signals configured by the network. For example, L1 measurements may measure signal power of reference signals corresponding to SSBs of activated TCI states. At signal 613, the UE periodically transmits the L1 measurement reports towards the source DU, and the source DU receives the periodic L1 measurement reports from the UE.

At operation 614, the source DU decides, based on the received L1 measurement report, whether to trigger the UE to acquire TA for the set of candidate cells (i.e., candidate cells for the handover configured by the CU at operation 608).

At operation 615, the UE performs TA acquisition for the candidate cell(s) using the TA acquisition method specified in the RRC reconfiguration message of operation 608. As described above, TA may be acquired based on random access (RA) procedure (either CFRA or CBRA), such as, without limitation, a physical downlink control channel (PDCCH) ordered RA procedure, UE-triggered RA procedure, and/or a higher layer triggered RA procedure from a network node (other than a L3 handover command), among others. In embodiments, TA may be acquired based on non-RA procedure methods, such as, without limitation, sounding reference signal (SRS) based TA acquisition, receive timing difference based mechanisms (such as those in LTE), and/or UE-based TA measurement, among others. Such RA-based and non-RA-based methods for TA acquisition are within the scope of the present disclosure. After operation 615, the UE may have TA values for the candidate cell(s) before a cell switch is triggered if the TA acquisition procedure was successful. If the TA acquisition procedure was not successful, the UE would not have TA values for the candidate cell(s).

At signal 616, the UE continues L1 measurement reporting and periodically transmits L1 measurement reports towards the source DU, and the source DU receives the periodic L1 measurement reports from the UE. At operation 617, the source DU decides whether the UE should change serving cells. In embodiments, the source DU may decide that the UE should change serving cells if the L1 measurements fall below a threshold, for example. Once the source DU decides that the UE should be handed over to a cell (e.g., target cell supported by target DU), the source DU triggers the cell switch using a cell switch command (e.g., a MAC CE).

At signal 618, the cell switch command (e.g., MAC CE) is transmitted by the source DU towards the UE, and the UE receives the cell switch command (e.g., MAC CE) from the source DU. In embodiments, the cell switch command may contain the TA value for the target cell. In embodiments, the cell switch command may contain a TA configuration for the UE to use during and/or after the cell switch. The source DU may have the TA configuration from receiving the RRC message at signal 609.

In response to the cell switch command, the UE applies the RRC configuration for the target cell of the target DU indicated by the cell switch command, to switch to the target DU/target cell as the serving cell. In embodiments, the UE may be configured to perform random access (RA) procedure to the target cell and target DU as shown in signals 619 and 620. However, in embodiments, the UE may be configured to not perform RA procedure to the target cell/target DU if it has already acquired the TA value of the target cell.

At signal 621, to initiate communication with the target DU, the UE transmits an RRC reconfiguration complete message towards the target DU using already configured uplink (UL) resources, and the target DU receives the RRC reconfiguration complete message from the UE. At signal 622, The target DU forwards the RRC reconfiguration complete message using UL RRC message transfer to transmit the RRC reconfiguration complete message towards the CU, and the CU receives the RRC reconfiguration complete message from the target DU. At signal 623, the CU transmits a UE context release command/request towards the source DU to release the UE context from the source DU, and the source DU receives the UE context release command/request from the CU. The source DU releases the UE context in response to the UE context release command/request. At signal 624, the source DU transmits a UE context release complete message towards the CU, and the CU receives the UE context release complete message from the source DU. At operation 625, the CU performs path switch to the target DU as the new DU supporting the serving cell.

The signals and operations of FIG. 6A and FIG. 6B are merely illustrative, and variations are contemplated to be within the scope of the present disclosure. For example, the signals and operations may assume one TA value per physical cell ID (PCI). In embodiments, to cover multi-TRP (multi-transmit receipt point) scenarios, the UE may be configured and required to acquire multiple TAs for a PCI, such as, for example, different TA values for different sets of TCI-states. In embodiments, the signals and operations may include others not illustrated in FIG. 6A and FIG. 6B. In embodiments, the signals and operations may not include every signal and operation illustrated in FIG. 6A and FIG. 6B. In embodiments, the signals and operations may be implemented in a different order than that illustrated in FIG. 6A and FIG. 6B. Such and other embodiments are contemplated to be within the scope of the present disclosure.

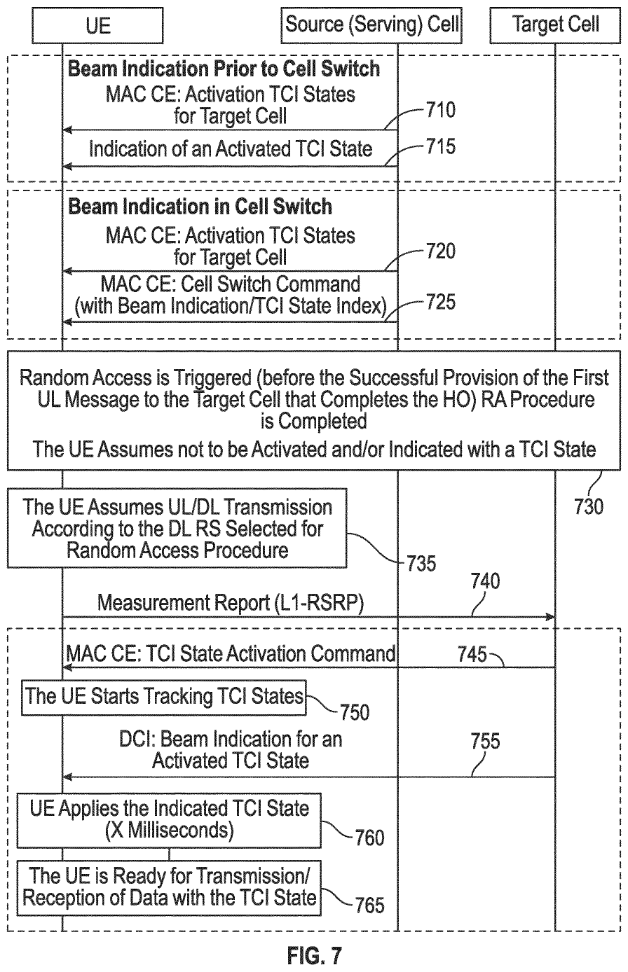

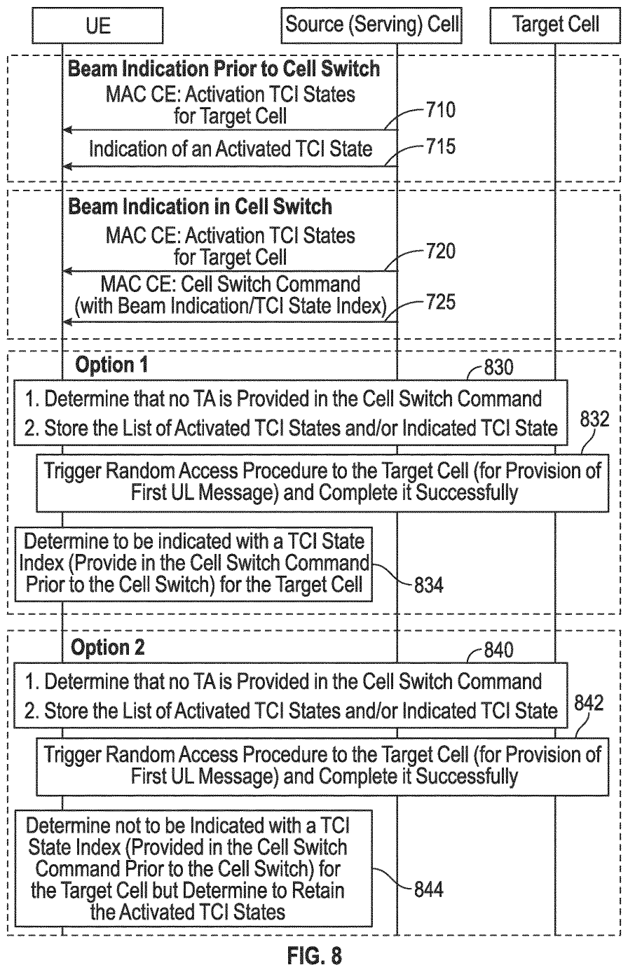

In connection with cell switch, various scenarios may occur. FIGS. 7-9 relate to various cell switch scenarios and will now be described. In summary, FIG. 7 relates to a cell switch scenario in which activated or indicated TCI states received before or in a cell switch command are not maintained after successfully completing the cell switch. FIG. 8 relates to a cell switch scenario in which no TA value is provided in the cell switch command. FIG. 9 relates to a cell switch scenario in which a TA value and uplink transmission resources (or in which monitoring scheduling of UL resources) are configured in the UE before or in the cell switch command. In FIGS. 7-9, the signals and operations are implemented among a UE, a serving cell, and a target cell for cell switch. One or more of the signals and operations may be implemented in connection with the LTM operations of FIGS. 6A and 6B. The UE may be similar to the UE 150 of FIGS. 1 and 2. The serving cell and the target cell may be similar to the network apparatuses 420 and/or 430.

In connection with FIGS. 7-9, the paragraphs below describe various signals and operations. It will be understood that the described signals may have associated operations and the described operations may have associated signals. Accordingly, a described signal may also be an operation and a described operation may also be a signal. Additionally, FIGS. 7-9 include a number of enumerated steps, but aspects of the operations may include additional steps before, after, and in between the enumerated steps. In some aspects, one or more of the enumerated steps may be omitted or performed in a different order. Such variations are contemplated to be within the scope of the present disclosure.

FIG. 7 is a diagram of an example embodiment of operations for cell switch in which activated or indicated TCI states received before or in a cell switch command are not maintained after successfully completing the cell switch. Signals 710 and 715 correspond to a one scenario, and signals 720 and 725 correspond to another scenario. Prior to signal 710 or 720, the UE has established a connection with a DU that supports the serving cell and has established a (logical) connection with the CU that supports the DU.

In the scenario of signals 710 and 715, activation of the TCI states for the target cell and an indication of at least one TCI state for the target cell are provided to the UE prior to the cell switch command. At signal 710, the serving cell transmits towards the UE a MAC CE that includes activation of TCI states for the target cell, and the UE receives the MAC CE. At signal 715, the serving cell transmits towards the UE an indication of at least one activated TCI state for the target cell, and the UE receives the indication of the activated TCI state for the target cell. After signal 715, the UE receives a cell switch command (not shown). The indicated TCI state (index) may be a joint TCI state which means that it is used for both downlink and uplink communication. Alternatively, the indicated TCI state (index) may be a pair of TCI states (i.e., a pair of downlink and uplink TCI states) or may be an indicated TCI state (index) (e.g., downlink or uplink TCI state).

In the scenario of signals 720 and 725, activated TCI states for the target cell are provided to the UE prior to the cell switch command, and the indicated TCI state is provided in the cell switch command. At signal 720, the serving cell transmits towards the UE a MAC CE that includes activation of TCI states for the target cell, and the UE receives the MAC CE. At signal 725, the serving cell transmits towards the UE a MAC CE that includes a cell switch command with an indication of an activated TCI state for the target cell, and the UE receives the MAC CE.

In various examples (not shown), the UE may receive a TCI state (index) in the cell switch command that operates to both activate and indicate at least one TCI state. In various examples, the UE may not have received any activation command for TCI state(s) prior to cell switch and may receive the activation in a cell switch command. In such examples, the at least one TCI state provided in the cell switch command is the activated and indicated TCI State.

After both signals 715 and 725, the operation proceeds to operation 730. At operation 730, random access procedure is triggered prior to successful completion of the cell switch and prior to the UE transmitting an uplink message (e.g., RRC reconfiguration complete signal 621 or other message that completes cell switch) towards the target cell. In various examples, the random access procedure may be triggered, prior to the successful provision of the at least one UL message from the UE to the target cell, due to a number N of retransmissions of the UL message (e.g., a configurable maximum number of retransmissions has been reached), or expiry of at least one timer monitoring the provision of UL message transmission (e.g., maximum amount time the UE has to try to transmit UL message on the provisioned UL grant has been reached), or observing the quality of the at least one RS of the TCI state to have lower quality than a threshold, or any other reason.

Continuing with operation 730, the UE and target cell perform and successfully complete random access procedure, and the target cell becomes a new serving cell for the UE. The random access procedure may be successfully completed by the UE transmitting towards the target cell at least one UL message that completes the cell switch procedure, such as the RRC configuration complete message (621, FIG. 6) or any message that completes the cell switch to the target cell. In various examples, the UL message may be a MAC CE. Successful completion of the random access procedure clears the activated and indicated TCI states for the target cell, and the UE then proceeds with no activated or indicated TCI states for the new serving cell. Rather, at operation 735, the UE prepares for uplink (UL) and downlink (DL) communications by measuring the DL reference signal (RS) selected for the random access procedure in operation 730. At operation 740, the UE transmits, towards the new serving cell, an L1 measurement report (e.g., L1-RSRP) based on measuring the DL RS, and the new serving cell receives the L1 measurement report.

The new serving cell may determine which TCI states to activate based on the L1 measurement report. At signal 745, the new serving cell transmits the reference signals corresponding to the activated TCI states towards the UE, and the UE monitors/tracks/receives the reference signals of the activated TCI states.

At operation 750, the UE tracks the activated TCI states (e.g., it monitors the at least one reference signal associated with the activated TCI states, e.g., for time/frequency tracking and/or path loss measurement). At signal 755, the new serving cell transmits downlink control information (DCI) that includes an indication of one of the activated TCI states, and the UE receives the DCI. At operation 760, the UE applies the indicated TCI state, and at block 765, the UE becomes ready for data communications with the new serving cell based on the indicated TCI state.

In summary, the signals and operations of FIG. 7 did not apply the activated or indicated TCI states for the target cell to the new serving cell after the random access procedure at operation 730 was completed. As a consequence, signals and operations 735-760 are needed before the UE may perform data communications with the new serving cell, leading to a delay between the completion of random access procedure and the data communications. This delay is reduced or eliminated by the signals and operations shown in FIG. 8 and FIG. 9, which are described below.

FIG. 8 relates to a cell switch scenario in which no TA value is provided in the cell switch command. In various examples, the UE may obtain/may receive a TA value prior to the cell switch command for the target cell but the cell switch command may not provide the TA value for the UE. In this case, the UE may assume that it is not provided with a TA value for the target cell (although it previously had obtained it). Alternatively, in various examples, the UE may determine that the previously acquired TA value is still valid even if a TA value is not provided in the cell switch command. In various examples, the UE determination may be a configurable configuration, i.e., if the TA value is not provided in the cell switch command but the UE had acquired it before the cell switch, the configuration may be configured to cause the UE to determine that the previous TA value is to be used, or the configuration may be configured to cause the UE to assume that no TA value is provided. FIG. 8 includes the same signals 710 and 715 and the same signals 720 and 725 as FIG. 7. After both signals 715 and 725, either option 1 (signals and operations 830-834) or option 2 (signals and operations 840-844) may be performed.

Both option 1 and option 2 involve the UE and the target cell performing and successfully completing random access procedure, so that the target cell becomes the new serving cell, and then maintaining at least the activated TCI states for the target cell as activated TCI states for the new serving cell. Option 1 additionally maintains the indicated TCI state for the target cell as the indicated TCI state for the new serving cell, while option 2 does not. In option 2, in which the indicated TCI state is not maintained, the UE may assume that the reference signal for downlink and uplink communication is the selected DL RS of the random access procedure, until the UE receives indication for at least one of the activated TCI states.

Regarding option 1, at operation 830, the UE determines that no TA value is provided in the cell switch command (i.e., it assumes in this scenario that it has no TA value for the target cell), and the UE stores/maintains the list of activated TCI states and the indicated TCI state (if available/if indicated). In various examples, if a TCI state (index) is provided in the cell switch command (e.g., at operation 725), the TCI state (index) may be stored at operation 830 as the activated and/or the indicated TCI state. At operation 832, random access procedure is triggered, and the UE and the target cell perform, and the UE successfully completes, the random access procedure. In various examples, the random access procedure may be triggered based on the determination that the cell switch command does not include a TA value, even though a timing advance (TA) value was acquired prior to the cell switch command. The UE acquires the TA value for the target cell via the random access procedure. After successful completion of the random access procedure (i.e., after completion of the cell switch), at operation 834, the UE maintains the activated TCI states for the target cell as activated TCI states for the new serving cell and maintains the indicated TCI state for the target cell as the indicated TCI state for the new serving cell. Maintaining the indicated TCI state enables the UE and the new serving cell to perform data communications right after random access procedure is completed, without the delay associated with signals and operations 735-760 in FIG. 7.

Regarding option 2, operation 840 is the same as operation 830, and operation 842 is the same as operation 832. After successful completion of the random access procedure, at operation 844, the UE maintains the activated TCI states for the target cell as activated TCI states for the new serving cell but does not maintain the indicated TCI state for the target cell as the indicated TCI state for the new serving cell. Maintaining the activated TCI state enables the UE and the new serving cell to avoid signals and operations 735-750 in FIG. 7. Thus, in option 2, signals and operations 755-765 are still needed for the new serving cell to indicate a TCI state to enable the UE and the new serving cell to perform data communications. However, compared to the operations of FIG. 7, option 2 still reduces the delay in readiness for data communications.

FIG. 9 relates to a cell switch scenario in which a TA value and uplink transmission resources (or in which monitoring scheduling of UL resources) are configured in the UE before or in the cell switch command. In such scenarios, either option 1 or option 2 shown in FIG. 9 may be used to reduce the delay in readiness for data communications, compared to FIG. 7. Both option 1 and option 2 involve the UE and the target cell performing and successfully completing random access procedure, so that the target cell becomes the new serving cell, and then maintaining at least the activated TCI states for the target cell as activated TCI states for the new serving cell. Option 1 additionally maintains the indicated TCI state for the target cell as the indicated TCI state for the new serving cell, while option 2 does not. In option 2, in which the indicated TCI state is not maintained, the UE may assume that the reference signal for downlink and uplink communication is the selected DL RS of the random access procedure, until the UE receives indication for at least one of the activated TCI states.

Regarding option 1, at operation 910, the UE determines that a TA value has been provided for the target cell and the UE is configured with UL transmission (either configured with UL resources or configured with monitoring of downlink control information for provision of the UL resources) for the target cell. At operation 912, the UE attempts transmission of an uplink message (e.g., RRC reconfiguration complete message 621 of FIG. 6B or other message that completes the cell switch procedure) towards the target cell using the TA value and the UL transmission resources. In the option 1 scenario, the attempted transmission is not immediately successful. At operation 914, prior to the attempted transmission completing, the UE determines that random access procedure to the target cell is triggered, and the UE stores the list of activated TCI states and the indicated TCI state (if available). In various examples, the random access procedure may be triggered due to a number N of retransmissions of the UL message (e.g., a configurable maximum number of retransmissions has been reached), or expiry of at least one timer monitoring the provision of UL message transmission (e.g., maximum amount time the UE has to try to transmit UL message on the provisioned UL grant has been reached), or observing the quality of the at least one RS of the TCI state to have lower quality than a threshold, or any other reason.

At block 916, the UE and the target cell perform and successfully complete random access procedure, and the target cell becomes the new serving cell. The random access procedure may be successfully completed by the UE transmitting towards the target cell at least one UL message that completes the cell switch procedure, such as the RRC configuration complete message (621, FIG. 6) or any message that completes the cell switch to the target cell. In various examples, the UL message may be a MAC CE. After successful completion of the random access procedure, at operation 918, the UE maintains the activated TCI states for the target cell as activated TCI states for the new serving cell and maintains the indicated TCI state for the target cell as the indicated TCI state for the new serving cell. Maintaining the indicated TCI state enables the UE and the new serving cell to perform data communications right after random access procedure is completed, without the delay associated with signals and operations 735-760 in FIG. 7.

Regarding option 2, signals and operations 920-926 are the same as those of 910-916. After successful completion of the random access procedure, at operation 928, the UE maintains the activated TCI states for the target cell as activated TCI states for the new serving cell but does not maintain the indicated TCI state for the target cell as the indicated TCI state for the new serving cell. Maintaining the activated TCI state enables the UE and the new serving cell to avoid signals and operations 735-750 in FIG. 7. Thus, in option 2, signals and operations 755-765 are still needed for the new serving cell to indicate a TCI state to enable the UE and the new serving cell to perform data communications. However, compared to the operations of FIG. 7, option 2 still reduces the delay in readiness for data communications.

Accordingly, compared to the signals and operations of FIG. 7, the signals and operations of FIG. 8 and FIG. 9 reduce or eliminate the delay in data communication readiness after the UE and the target cell successfully complete random access procedure, which leads to improved time and resource utilization by the UE and by the network system.

The signals and operations of FIGS. 7-9 are merely examples, and variations are contemplated to be within the scope of the present disclosure.

As an example of variations, for the downlink control reception at the target cell, for CORESET with index 0 or/and CORESETs other than index 0 which are associated with common search space (CSS) sets other than Type-3-PDCCH (physical downlink control channel) CSS sets, if the followUnifedTCI-State is not enabled, the UE may assume that it has not been indicated with a TCI state for the target cell (new serving cell). Persons skilled in the art will understand CORESETs, CSS, and PDCCH and their parameters and operations.

As an example of another variation, for the downlink control reception at the target cell, for a CORESET index value being associated with at least one type of physical downlink control channel (PDCCH) common search space (CSS), if a configuration includes at least one field corresponding to not applying the indication of a the one TCI state, then the UE may determine that it has not been indicated with a TCI state for the target cell. Based on the determination, the UE may apply a quasi co-located (QCL) source for monitoring at least one CSS on at least one CORESET based on a reference signal selected for the random access procedure.

In some variations, only an indicated TCI state remains an activated TCI state and TCI states other than the indicated TCI state are deactivated.

In some variations, the cell switch command may include a configuration for which TCI states to maintain. After a UE successfully completes a random access procedure with a target cell, the UE may, based on the indication in the cell switch command, determine to: maintain activated TCI states but not maintain an indicated TCI state, or maintain an indicated TCI state (which is also the activated) but not maintain (the other) activated TCI states, or maintain both the indicated TCI state and the activated TCI states. In another example, the UE could be pre-configured to perform one of these actions (maintain/not maintain) upon receiving the cell switch command and after successful completion of the random access procedure, e.g. when the RA procedure is triggered before the completion of the cell switch. Alternatively, whether or not the UE determines to maintain one or more of the TCI States (both indicated and activated TCI states, or only activated TCI States or only the indicated TCI State) may be configurable by RRC (and configurable per target cell). When the TCI state are maintained as activated but not indicated, it could allow target cell to select the indicated TCI state after completion of the cell switch e.g. based on the random access procedure. In another example, when the UE maintains only indicated TCI state (which has also been one of the activated TCI States while other previously activated TCI states are now deactivated/not activated), it enables the network communicate with UE after the cell switch but it could reduce the UE burden not to monitor all the previously active TCI States (e.g. target cell could wait for the latest L1-report to determine activation of set of TCI States while the UE could be still served using the indicated TCI state). In an example where the UE is configured to maintain both the indicated TCI state and activated TCI states, this enables communication using the indicated TCI state while the other activated TCI states are being monitored by the UE for low latency beam switch in the target cell.

In some variations, in performing random access procedure, the UE may to select a signal synchronization block (SSB) or a quasi-co-located (QCL) source SSB, corresponding to an indicated TCI state, if the respective SSB or QCL source SSB has a reference signal receive power (RSRP) that is above a threshold value.

In some variations, separate activations and indications of TCI states may be separately provided for each candidate cell.

As another example of variations, in various embodiments, whether the TCI states are stored/maintained, as described in connection with FIGS. 7-9, may be configurable. The configuration may be provided using RRC signaling. The configuration may be part of the candidate cell configuration (e.g., LTM configuration). The configuration may be specific for a specific cell or set/group of candidate cells. The configuration may indicate whether the UE is configured to store/maintain the activated TCI states for the target cell. In various examples, the configuration could configure the UE to store the activation (and/or indication) of TCI states for intra-DU cells. In various examples, the configuration could configure the UE not to store the activation (and/or indication) of TCI states for inter-DU cells. Whether the cell is an intra- or inter DU cell may not be visible to UE and the UE may simply apply the configuration. The configuration may indicate whether the UE is not configured to store/maintain the activated TCI states for the target cell. The configuration may indicate whether the UE is configured to store/maintain the indicated TCI state (i.e., the indicated TCI State is maintained and it is also activated). In various examples, the cell switch command may indicate whether the TCI states for the target cell are maintained activated. In various examples, the cell switch command may indicate whether the indicated TCI state for the target cell is maintained to be indicated. Such and other variations are contemplated to be within the scope of the present disclosure.

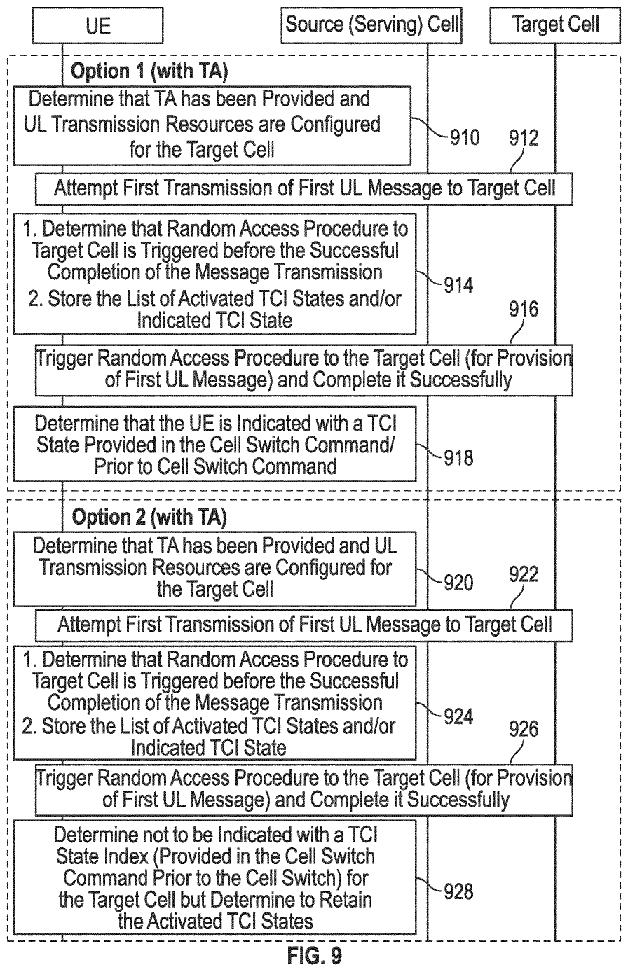

Referring now to FIG. 10, there is shown a flow diagram of an example of UE operations. The operations of FIG. 10 encompass both FIG. 8 and FIG. 9 and encompass both options of FIG. 8 and both options of FIG. 9. At block 1010, the operation involves receiving, from a serving cell, one or more activated transmission configuration indicator (TCI) states for a candidate cell. At block 1020, the operation involves receiving, from the serving cell, a cell switch command to switch from the serving cell to the candidate cell, where the candidate cell is the target cell of the cell switch command. At block 1030, the operation involves, in response to the cell switch command, performing random access procedure with the target cell, where the target cell becomes the new serving cell for the UE after the random access procedure is successfully completed. At block 1040, the operation involves, after the random access procedure with the target cell is successfully completed, maintaining the one or more of activated TCI states as activated TCI states for the new serving cell.

The operations of FIG. 10 are examples. In some aspects, the operations may include additional steps before, after, and in between the enumerated steps. In some aspects, one or more of the enumerated steps may be omitted or performed in a different order. Such variations are contemplated to be within the scope of the present disclosure.

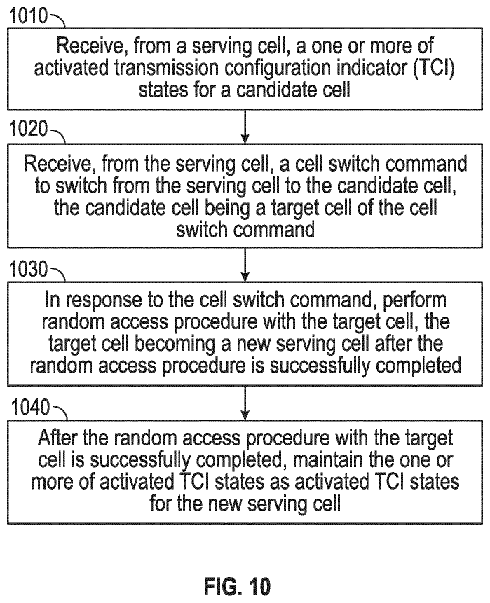

Referring now to FIG. 11, there is shown a flow diagram of an example of target cell operations. The operations of FIG. 11 encompass both FIG. 8 and FIG. 9 and encompass both options of FIG. 8 and both options of FIG. 9. At block 1110, the operation involves transmitting, to a serving cell for a user equipment apparatus (UE), a plurality of transmission configuration indicator (TCI) states which may be activated for the candidate cell, where the transmitting occurs prior to a cell switch command for the UE to switch from the serving cell to the candidate cell. At block 1120, the operation involves, after the cell switch command, performing random access procedure with the UE, where the candidate cell becomes the new serving cell for the UE after the random access procedure is successfully completed. At block 1130, the operation involves, after the random access procedure with the UE is successfully completed, communicating with the UE using the plurality of activated TCI states as activated TCI states for the new serving cell, where the communicating occurs without the new serving cell transmitting the activated TCI states to the UE.

The operations of FIG. 11 are examples. In some aspects, the operations may include additional steps before, after, and in between the enumerated steps. In some aspects, one or more of the enumerated steps may be omitted or performed in a different order. Such variations are contemplated to be within the scope of the present disclosure.

Referring now to FIG. 12, there is shown a block diagram of example components of a UE or a network apparatus. The apparatus includes an electronic storage 1210, a processor 1220, a memory 1250, and a network interface 1240. The various components may be communicatively coupled with each other. The processor 1220 may be and may include any type of processor, such as a single-core central processing unit (CPU), a multi-core CPU, a microprocessor, a digital signal processor (DSP), a System-on-Chip (SoC), or any other type of processor. The memory 1250 may be a volatile type of memory, e.g., RAM, or a non-volatile type of memory, e.g., NAND flash memory. The memory 1250 includes processor-readable instructions that are executable by the processor 1220 to cause the apparatus to perform various operations, including those mentioned herein, such as the operations of FIGS. 3 and 5-11.

The electronic storage 1210 may be and include any type of electronic storage used for storing data, such as hard disk drive, solid state drive, and/or optical disc, among other types of electronic storage. The electronic storage 1210 stores processor-readable instructions for causing the apparatus to perform its operations and stores data associated with such operations, such as storing data relating to 5G NR standards, among other data. The network interface 240 may implement wireless networking technologies such as 5G NR and/or other wireless networking technologies.

The components shown in FIG. 12 are merely examples, and persons skilled in the art will understand that an apparatus includes other components not illustrated and may include multiples of any of the illustrated components. Such and other embodiments are contemplated to be within the scope of the present disclosure.

Further embodiments of the present disclosure include the following examples.

Example 1-1. A network apparatus supporting a candidate cell, the network apparatus comprising:
one or more processors; and
at least one memory storing instructions which, when executed by the one or more processors, cause the network apparatus at least to:
   transmit, to a serving cell for a user equipment apparatus (UE), one or more transmission configuration indicator (TCI) states which may be activated for the candidate cell, wherein the transmitting occurs prior to a cell switch command for the UE to switch from the serving cell to the candidate cell;
   after the cell switch command, perform random access procedure with the UE, the candidate cell becoming a new serving cell after the random access procedure is successfully completed; and
   after the random access procedure with the UE is successfully completed, communicate with the UE using at least one of the one or more activated TCI states as one or more activated TCI states for the new serving cell,
wherein the communicating occurs without the new serving cell transmitting the one or more activated TCI states to the UE.

Example 1-2. The network apparatus of Example 1-1, wherein in performing the random access procedure with the UE, the instructions, when executed by the one or more processors, cause the network apparatus at least to, transmit, to the UE, a timing advance (TA) value for the candidate cell.

Example 1-3. The network apparatus of Examples 1-1 or 1-2, wherein the instructions, when executed by the one or more processors, further cause the network apparatus at least to, after the random access procedure with the UE is successfully completed, communicate with the UE using one of the one or more activated TCI states as an indicated TCI state for the new serving cell,
wherein the communicating occurs without the new serving cell transmitting the indicated TCI state to the UE.

Example 1-4. The network apparatus of Example 1-3, wherein the one or more activated TCI states for the new serving cell includes only the indicated TCI state for the new serving cell,
wherein among the one or more activated TCI states which may be activated, TCI states other than the indicated TCI state are deactivated.

Example 1-5. A processor-implemented method in a network apparatus supporting a candidate cell, the method comprising:
transmitting, to a serving cell for a user equipment apparatus (UE), one or more transmission configuration indicator (TCI) states which may be activated for the candidate cell, wherein the transmitting occurs prior to a cell switch command for the UE to switch from the serving cell to the candidate cell;
after the cell switch command, performing random access procedure with the UE, the candidate cell becoming a new serving cell after the random access procedure is successfully completed; and
after the random access procedure with the UE is successfully completed, communicating with the UE using at least one of the one or more activated TCI states as one or more activated TCI states for the new serving cell,
wherein the communicating occurs without the new serving cell transmitting the activated TCI states to the UE.

Example 1-6. The processor-implemented method of Example 1-5, wherein performing the random access procedure with the UE comprises transmitting, to the UE, a timing advance (TA) value for the candidate cell.

Example 1-7. The processor-implemented method of Examples 1-5 or 1-6, further comprising, after the random access procedure with the UE is successfully completed, communicating with the UE using one of the one or more activated TCI states as an indicated TCI state for the new serving cell,
wherein the communicating occurs without the new serving cell transmitting the indicated TCI state to the UE.

Example 1-8. The processor-implemented method of Example 1-7, wherein the one or more activated TCI states for the new serving cell includes only the indicated TCI state for the new serving cell,
wherein among the one or more activated TCI states which may be activated, TCI states other than the indicated TCI state are deactivated or not considered.

Example 2-1. A user equipment apparatus comprising:
means for receiving, from a serving cell, one or more activated transmission configuration indicator (TCI) states for a candidate cell;
means for receiving, from the serving cell, a cell switch command to switch from the serving cell to the candidate cell, the candidate cell being a target cell of the cell switch command;
means for, in response to the cell switch command, performing random access procedure with the target cell, the target cell becoming a new serving cell after the random access procedure is successfully completed; and
means for, after the random access procedure with the target cell is successfully completed, maintaining at least one of the one or more of activated TCI states as one or more activated TCI states for the new serving cell.

Example 2-2. The user equipment apparatus of Example 2-1, further comprising:
means for, in response to the cell switch command, determining that no timing advance (TA) value has been provided for the target cell in the cell switch command; and
means for, receiving a TA value for the target cell via the random access procedure.

Example 2-3. The user equipment apparatus of Example 2-1 or 2-2, further comprising:
means for, prior to performing the random access procedure with the target cell, receiving an indication of one TCI state of the one or more activated TCI states; and
means for, after the random access procedure with the target cell is successfully completed, maintaining the indication of the one TCI state as an indicated TCI state for the new serving cell.

Example 2-4. The user equipment apparatus of Example 2-3, wherein the one or more activated TCI states for the new serving cell includes only the indicated TCI state for the new serving cell,
wherein among the one or more activated TCI states, TCI states other than the indicated TCI state are deactivated.

Example 2-5. The user equipment apparatus of Example 2-1 or 2-2, further comprising:
means for, prior to performing the random access procedure with the target cell, receiving in the cell switch command an indication of one TCI state of the one or more activated TCI states; and
means for, after the random access procedure with the target cell is successfully completed, determining, based on the cell switch command, to one of:
   maintain at least one of the one or more activated TCI states but not maintain the indication of the one TCI state,
   maintain the indication of the one TCI state but not maintain the one or more activated TCI states, or
   maintain at least one of the one or more activated TCI states and maintain the indication of the one TCI state.

Example 2-6. The user equipment apparatus of Example 2-1 or 2-2, further comprising:
means for, prior to performing the random access procedure with the target cell, receiving an indication of one TCI state of the one or more of activated TCI states; and
means for, after the random access procedure with the target cell is successfully completed, determining to not maintain the indication of the one TCI state as an indicated TCI state for the new serving cell.

Example 2-7. The user equipment apparatus of Example 2-6, wherein the determination to not maintain the indication of the one TCI state is based on:
a CORESET index value being associated with at least one type of physical downlink control channel (PDCCH) common search space (CSS), and
a configuration comprising at least one field value corresponding to not applying the indication of the one TCI state,
wherein the instructions, when executed by the one or more processors, further cause the user equipment apparatus at least to, based on the determination, apply a quasi co-located (QCL) source for monitoring at least one CSS on at least one CORESET based on a reference signal selected for the random access procedure.

Example 2-8. The user equipment apparatus of Example 2-3, wherein the means for performing the random access procedure with the target cell comprises means for selecting one of a signal synchronization block (SSB) or a quasi-co-located (QCL) source SSB, corresponding to the indicated one TCI state, if the respective SSB or QCL source SSB has a reference signal receive power (RSRP) that is above a threshold value.

Example 2-9. The user equipment apparatus of any one of Examples 2-1 to 2-8, further comprising:
means for determining that a timing advance (TA) value was acquired prior to the cell switch command and that the cell switch command does not include a TA value; and
means for, based on the determination, deciding that random access procedure is triggered.

Example 2-10. The user equipment apparatus of Example 2-1, further comprising:
means for, in response to the cell switch command, determining that a timing advance (TA) value for the target cell has been acquired and that one of: uplink resources are configured for the target cell, or scheduling of the uplink resources is to be monitored;
means for, based on the determination, transmitting an uplink message to the target cell using the uplink resources; and
means for, determining that the random access procedure is triggered before the uplink message is successfully transmitted to the target cell,
wherein the random access procedure is performed in response to the random access procedure being triggered.

Example 2-11. The user equipment apparatus of Example 2-10, wherein the instructions, when executed by the one or more processors, further cause the user equipment apparatus at least to:
means for, prior to performing the random access procedure with the target cell, receiving an indication of one TCI state of the one or more activated TCI states; and
means for, after the random access procedure with the target cell is successfully completed, maintaining the indication of the one TCI state as an indicated TCI state for the new serving cell.

Example 2-12. The user equipment apparatus of Example 2-10, further comprising:
means for, prior to performing the random access procedure with the target cell, receiving an indication of one TCI state of the one or more activated TCI states; and
means for, after the random access procedure with the target cell is successfully completed, determining to not maintain the indication of the one TCI state as an indicated TCI state for the new serving cell.

Example 2-13. The user equipment apparatus of Example 2-12, wherein the determination to not maintain the indication of the one TCI state is based on:
a CORESET index value being associated with at least one type of physical downlink control channel (PDCCH) common search space (CSS), and
a configuration comprising at least one field value corresponding to not applying the indication of the one TCI state,
the user equipment apparatus further comprising: means for, based on the determination, applying a quasi co-located (QCL) source for monitoring at least one CSS on at least one CORESET based on a reference signal selected for the random access procedure.

Example 2-14. The user equipment apparatus of any one of Examples 2-1 to 2-13, wherein the instructions, when executed by the one or more processors, further cause the user equipment apparatus at least to:
means for receiving, from the serving cell, for each candidate cell of a plurality of candidate cells, one or more respective activated transmission configuration indicator (TCI) states for the respective candidate cell,
wherein the plurality of candidate cells comprises the candidate cell.

Example 2-15. The user equipment apparatus of any one of Examples 2-1 to 2-14, wherein the cell switch command is a layer 1/layer 2 triggered mobility (LTM) cell switch command.

Example 2-16. A processor-implemented method comprising:
receiving, from a serving cell, one or more activated transmission configuration indicator (TCI) states for a candidate cell;
receiving, from the serving cell, a cell switch command to switch from the serving cell to the candidate cell, the candidate cell being a target cell of the cell switch command;
in response to the cell switch command, performing random access procedure with the target cell, the target cell becoming a new serving cell after the random access procedure is successfully completed; and
after the random access procedure with the target cell is successfully completed, maintaining the one or more activated TCI states as activated TCI states for the new serving cell.

Example 2-17. The processor-implemented method of Example 2-16, further comprising:
in response to the cell switch command, determining that no timing advance (TA) value has been provided for the target cell in the cell switch command; and
receiving a TA value for the target cell via the random access procedure.

Example 2-18. The processor-implemented method of Example 2-16 or 2-17, further comprising:
prior to performing the random access procedure with the target cell, receiving an indication of one TCI state of the one or more activated TCI states; and
after the random access procedure with the target cell is successfully completed, maintaining the indication of the one TCI state as an indicated TCI state for the new serving cell.

Example 2-19. The processor-implemented method of Example 2-18, wherein the one or more activated TCI states for the new serving cell includes only the indicated TCI state for the new serving cell,
wherein among the one or more activated TCI states, TCI states other than the indicated TCI state are deactivated or not considered.

Example 2-20. The processor-implemented method of Example 2-16 or 2-17, further comprising:
prior to performing the random access procedure with the target cell, receiving an indication of one TCI state of the one or more activated TCI states; and
after the random access procedure with the target cell is successfully completed, determining, based on the cell switch command, to one of:
   maintain at least one of the one or more activated TCI states but not maintain the indication of the one TCI state,
   maintain the indication of the one TCI state but not maintain the one or more activated TCI states, or
   maintain at least one of the one or more activated TCI states and maintain the indication of the one TCI state.

Example 2-21. The processor-implemented method of Example 2-16 or 2-17, further comprising:
prior to performing the random access procedure with the target cell, receiving an indication of one TCI state of the one or more of activated TCI states; and
after the random access procedure with the target cell is successfully completed, determining to not maintain the indication of the one TCI state as an indicated TCI state for the new serving cell.

Example 2-22. The processor-implemented method of Example 2-21, wherein the determination to not maintain the indication of the one TCI state is based on:
a CORESET index value being associated with at least one type of physical downlink control channel (PDCCH) common search space (CSS), and
a configuration comprising at least one field value corresponding to not applying the indication of the one TCI state,
the method further comprising, based on the determination, applying a quasi co-located (QCL) source for monitoring at least one CSS on at least one CORESET based on a reference signal selected for the random access procedure.

Example 2-23. The processor-implemented method of Example 2-18, wherein performing the random access procedure with the target cell comprises selecting one of a signal synchronization block (SSB) or a quasi-co-located (QCL) source SSB, corresponding to the indicated one TCI state, if the respective SSB or QCL source SSB has a reference signal receive power (RSRP) that is above a threshold value.

Example 2-24. The processor-implemented method of any one of Examples 2-16 to 2-23, further comprising:
determining that a timing advance (TA) value was acquired prior to the cell switch command and that the cell switch command does not include a TA value; and
based on the determination, deciding that random access procedure is triggered.

Example 2-25. The processor-implemented method of Example 2-16, further comprising:
in response to the cell switch command, determining that a timing advance (TA) value for the target cell has been acquired and that one of: uplink resources are configured for the target cell, or scheduling of the uplink resources is to be monitored;
based on the determination, transmitting an uplink message to the target cell using the uplink resources; and
determining that the random access procedure is triggered before the uplink message is successfully transmitted to the target cell,
wherein the random access procedure is performed in response to the random access procedure being triggered.

Example 2-26. The processor-implemented method of Example 2-25, further comprising:
prior to performing the random access procedure with the target cell, receiving an indication of one TCI state of the one or more activated TCI states; and
after the random access procedure with the target cell is successfully completed, maintaining the indication of the one TCI state as an indicated TCI state for the new serving cell.

Example 2-27. The processor-implemented method of Example 2-25, further comprising:
prior to performing the random access procedure with the target cell, receiving an indication of one TCI state of the one or more activated TCI states; and
after the random access procedure with the target cell is successfully completed, determining to not maintain the indication of the one TCI state as an indicated TCI state for the new serving cell.

Example 2-28. The processor-implemented method of Example 2-27, wherein the determination to not maintain the indication of the one TCI state is based on:
a CORESET index value being associated with at least one type of physical downlink control channel (PDCCH) common search space (CSS), and
a configuration comprising at least one field value corresponding to not applying the indication of the one TCI state,
the method further comprising, based on the determination, apply a quasi co-located (QCL) source for monitoring at least one CSS on at least one CORESET based on a reference signal selected for the random access procedure.

Example 2-29. The processor-implemented method of any one of Examples 2-16 to 2-28, further comprising:
receiving, from the serving cell, for each candidate cell of a plurality of candidate cells, one or more respective activated transmission configuration indicator (TCI) states for the respective candidate cell,
wherein the plurality of candidate cells comprises the candidate cell.

Example 2-30. The processor-implemented method of any one of Examples 2-16 to 2-29, wherein the cell switch command is a layer 1/layer 2 triggered mobility (LTM) cell switch command.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, Javascript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

1. A user equipment apparatus comprising:
one or more processors; and
at least one memory storing instructions which, when executed by the one or more processors, cause the user equipment apparatus at least to:
receive, from a serving cell, activated transmission configuration indicator (TCI) states for a candidate cell;
receive, from the serving cell, a cell switch command to switch from the serving cell to the candidate cell, the candidate cell being a target cell of the cell switch command, wherein the cell switch command indicates only one TCI state of the more activated TCI states for the candidate cell;
maintain the indicated TCI state and deactivate the other activated TCI state or TCI states for the candidate cell;
in response to the cell switch command, determine that no timing advance (TA) value has been provided for the target cell in the cell switch command and perform random access procedure with the target cell, the target cell becoming a new serving cell after the random access procedure is successfully completed;
receive a TA value for the target cell via the random access procedure; and
after the random access procedure with the target cell is successfully completed, maintain the indication of the one TCI state as an indicated TCI state for the new serving cell.

2-4. (canceled)

5. The user equipment apparatus of claim 1, wherein the instructions, when executed by the one or more processors, further cause the user equipment apparatus at least to:
after the random access procedure with the target cell is successfully completed, determine to
maintain the indicated TCI state and deactivate the other activated TCI state or TCI states for the candidate cell.

6-7. (canceled)

8. The user equipment apparatus of claim 1, wherein in performing the random access procedure with the target cell, the instructions, when executed by the one or more processors, cause the user equipment apparatus at least to select one of a signal synchronization block (SSB) or a quasi-co-located (QCL) source SSB, corresponding to the indicated one TCI state, if the respective SSB or QCL source SSB has a reference signal receive power (RSRP) that is above a threshold value.

9. The user equipment apparatus of claim 1, wherein the instructions, when executed by the one or more processors, further cause the user equipment apparatus at least to:
determine that a timing advance (TA) value was acquired prior to the cell switch command and that the cell switch command does not include a TA value; and
based on the determination, decide that random access procedure is triggered.

10-13. (canceled)

14. The user equipment apparatus of claim 1, wherein the instructions, when executed by the one or more processors, further cause the user equipment apparatus at least to:
receive, from the serving cell, for each candidate cell of a plurality of candidate cells, respective activated transmission configuration indicator (TCI) states for the respective candidate cell,
wherein the plurality of candidate cells comprises the candidate cell.

15. The user equipment apparatus of claim 1, wherein the cell switch command is a layer 1/layer 2 triggered mobility (LTM) cell switch command.

16. A processor-implemented method comprising:
receiving, from a serving cell, activated transmission configuration indicator (TCI) states for a candidate cell;
receiving, from the serving cell, a cell switch command to switch from the serving cell to the candidate cell, the candidate cell being a target cell of the cell switch command, wherein the cell switch command indicates only one TCI state of the more activated TCI states for the candidate cell;
maintaining the indicated TCI state and deactivate the other activated TCI state or TCI states for the candidate cell;
in response to the cell switch command, determining that no timing advance (TA) value has been provided for the target cell in the cell switch command and performing random access procedure with the target cell, the target cell becoming a new serving cell after the random access procedure is successfully completed;
receiving a TA value for the target cell via the random access procedure; and
after the random access procedure with the target cell is successfully completed, maintaining the indication of the one TCI state as an indicated TCI state for the new serving cell.

17-19. (canceled)

20. The processor-implemented method of claim 16, further comprising:
after the random access procedure with the target cell is successfully completed, determining to
maintain the indicated TCI state and deactivate the other activated TCI state or TCI states for the candidate cell.

21-22. (canceled)

23. The processor-implemented method of claim 16, wherein performing the random access procedure with the target cell comprises selecting one of a signal synchronization block (SSB) or a quasi-co-located (QCL) source SSB, corresponding to the indicated one TCI state, if the respective SSB or QCL source SSB has a reference signal receive power (RSRP) that is above a threshold value.

24. The processor-implemented method of claim 16, further comprising:
determining that a timing advance (TA) value was acquired prior to the cell switch command and that the cell switch command does not include a TA value; and
based on the determination, deciding that random access procedure is triggered.

25-28. (canceled)

29. The processor-implemented method of claim 16, further comprising:
receiving, from the serving cell, for each candidate cell of a plurality of candidate cells, respective activated transmission configuration indicator (TCI) states for the respective candidate cell,
wherein the plurality of candidate cells comprises the candidate cell.

30. (Original The processor-implemented method of claim 16, wherein the cell switch command is a layer 1/layer 2 triggered mobility (LTM) cell switch command.
